(19) United States
(12) Patent Application Publication
(10) Pub. No.: US 2025/0308078 A1
(43) Pub. Date: Oct. 2, 2025

(54) METHOD AND APPARATUS FOR DECODING IMAGE

(71) Applicants: Electronics and Telecommunications Research Institute, Daejeon (KR); UIF (University Industry Foundation), Yonsei University, Seoul (KR)

(72) Inventors: Ha Hyun LEE, Daejeon (KR); Gun BANG, Daejeon (KR); Soo Woong KIM, Daejeon (KR); Jun Sik KIM, Daejeon (KR); Ji Hoon DO, Daejeon (KR); Seong Jun BAE, Daejeon (KR); Jung Won KANG, Daejeon (KR); Jin Soo CHOI, Daejeon (KR); Seo Ha KIM, Seoul (KR); Jeong Min BAE, Seoul (KR); Young Jung UH, Seoul (KR); Young Sik YUN, Seoul (KR)

(21) Appl. No.: 19/094,659

(22) Filed: Mar. 28, 2025

(30) Foreign Application Priority Data
Mar. 29, 2024 (KR) 10-2024-0043684
Mar. 25, 2025 (KR) 10-2025-0038361

(51) Int. Cl. G06T 9/00; G06T 3/4046

(52) U.S. Cl. CPC G06T 9/002; G06T 3/4046

(57) ABSTRACT

A method of decoding an image according to a present disclosure, the method includes decoding a Gaussian parameter and Gaussian embedding for a first Gaussian in a canonical space; obtaining a variation of a Gaussian parameter for the first Gaussian by inputting the Gaussian embedding into a deformation function; and reconstructing a second Gaussian at a target timestamp by applying the variation to the Gaussian parameter for the first Gaussian, wherein the Gaussian embedding is derived individually for each Gaussian.

### CROSS-REFERENCE TO RELATED APPLICATION

This application claims priority under 35 U.S.C. § 119 to Korean Patent Application No. 10-2024-0043684 filed in the Korean Intellectual Property Office on Mar. 29, 2024, and Korean Patent Application No. 10-2025-0038361 filed in the Korean Intellectual Property Office on Mar. 25, 2025, the entire contents of which are hereby incorporated by reference.

### BACKGROUND OF THE INVENTION

### Field of the Invention

The present disclosure relates to an image decoding method and device, and more particularly, to an image decoding method and device using a deformation function based on embedding information.

### Description of the Related Art

Regarding virtual reality (VR) and augmented reality (AR) technologies, various studies are actively being conducted to improve image quality and provide a better viewing experience. In the field of image rendering, Gaussian Splatting is being developed to obtain images from any arbitrary viewpoint by optimizing Gaussian parameter and inputting multi-view images for flexible and rich scene expression. In particular, a technique for deforming Gaussian parameter over time was introduced to express dynamic scenes.

### SUMMARY OF THE INVENTION

It is an object of the present disclosure to represent unique spatial characteristics for each individual Gaussian by deriving Gaussian embedding for each individual Gaussian.

It is a further object of the present disclosure to express dynamic characteristics of a scene by deriving temporal embedding.

It is a further object of the present disclosure to obtain variation of Gaussian parameter over time through a deformation function that takes Gaussian embedding and/or temporal embedding as input.

It is a further object of the present disclosure to obtain the position-independent variation of a Gaussian parameter using a deformation function that takes Gaussian embedding and/or temporal embedding as input.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method of decoding an image, the method including decoding a Gaussian parameter and Gaussian embedding for a first Gaussian in a canonical space; obtaining a variation of the Gaussian parameter for the first Gaussian by inputting the Gaussian embedding into a deformation function; and reconstructing a second Gaussian at a target timestamp by applying the variation to the Gaussian parameter for the first Gaussian, wherein the Gaussian embedding is derived individually for each Gaussian.

In accordance with an aspect of the present disclosure, the above and other objects can be accomplished by the provision of a device for decoding an image, the device including a Gaussian information decoding unit that decodes a Gaussian parameter and Gaussian embedding for a first Gaussian in a canonical space; a Gaussian parameter variation acquisition unit that obtains a variation of the Gaussian parameter for the first Gaussian by inputting the Gaussian embedding into a deformation function; and a Gaussian reconstruction unit that reconstructs a second Gaussian at a target timestamp by applying the variation to the Gaussian parameter for the first Gaussian, wherein the Gaussian embedding is derived individually for each Gaussian.

In the method of decoding the image according to the present disclosure, the Gaussian embedding is expressed as a 32-dimensional vector.

In the method of decoding the image according to the present disclosure, the variation is obtained by further inputting temporal embedding into the deformation function.

In the method of decoding the image according to the present disclosure, the temporal embedding is expressed as a vector corresponding to at least one frame in a one-dimensional feature grid comprising N frames.

In the method of decoding the image according to the present disclosure, the temporal embedding is derived for each dynamic state of a scene.

In the method of decoding the image according to the present disclosure, a device for decoding the image that performs the method of decoding the image comprises a pre-defined network structure, wherein the pre-defined network structure comprises at least one layer, and the at least one layer has 128 hidden units.

In the method of decoding the image according to the present disclosure, the temporal embedding is at least one of high-resolution temporal embedding or low-resolution temporal embedding depending on whether the device that performs the method of decoding the image is a high-resolution image decoding device or a low-resolution image decoding device.

In the method of decoding the image according to the present disclosure, the high-resolution temporal embedding is obtained for each of N frames, and the low-resolution temporal embedding is obtained only for a frame at a downsampled position among the N frames.

In the method of decoding the image according to the present disclosure, a down sampling rate is ⅕.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing the Gaussian generation, optimization, and rendering process.

FIG. 2 is a diagram to explain the field-based Gaussian splatting method.

FIG. 3 is a drawing showing an example of field-based Gaussian splatting method, which shows a problem in which Gaussians at similar positions are predicted to have similar variations, resulting in a degradation in image quality.

FIG. 4 is a flowchart explaining a method of encoding an image using a deformation function based on Gaussian embedding and/or temporal embedding.

FIG. 5 is a flowchart explaining a method of decoding an image using a deformation function based on Gaussian embedding and/or temporal embedding.

FIG. 6 is a block diagram of a device for encoding an image using a deformation function based on Gaussian embedding and/or temporal embedding.

FIG. 7 is a block diagram of a device for decoding an image using a deformation function based on Gaussian embedding and/or temporal embedding.

FIG. 8 is a diagram showing the process of deriving low-resolution temporal embedding by downsampling high-resolution temporal embedding at a specific timestamp.

FIG. 9 is a diagram showing the structure of a deformation function that obtains a variation of a Gaussian parameter based on embedding information.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

Gaussian is a probability distribution that represents the distribution of data in a three-dimensional space, and represents the density of data, that is, how densely data is concentrated in a specific area of space. The Gaussian is defined as a mean vector and a covariance matrix.

Canonical space represents a three-dimensional space at a reference timestamp.

Embedding means representing data in a vector space by mapping data to a vector space.

Splatting or Gaussian splatting means generating a three-dimensional scene from a two-dimensional image by scattering a Gaussian with probability distribution in space.

Hereinafter, with reference to the attached drawings, an embodiment of the present disclosure will be described in more detail.

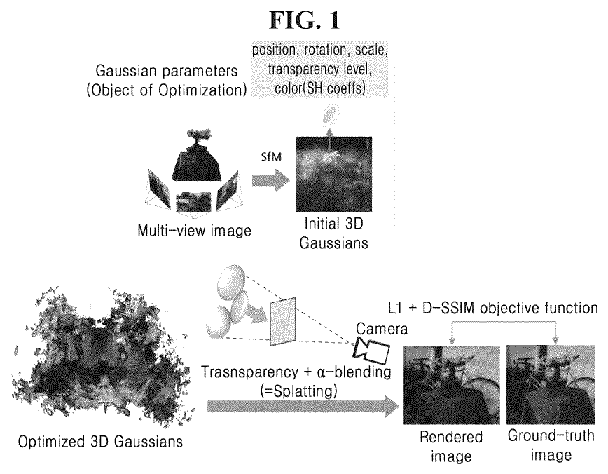

FIG. 1 is a diagram showing the process of generating and optimizing a Gaussian and the process of rendering an image generated through the optimized Gaussian. When multi-view images captured at different timestamps are input, the initial Gaussian is generated using Structure from Motion (SfM). SfM means a technique that simultaneously estimates the 3D structure of the captured scene and the movement of the camera.

Meanwhile, Gaussian is generated based on Gaussian parameter. As an example, Gaussian is expressed by Gaussian parameters such as spatial position, rotation, scale, transparency level, and color.

The generated 3D Gaussian is projected onto a 2D image and rendered. The loss is calculated by comparing the projected image with the ground-truth image. The Gaussian is optimized by adaptively adjusting the Gaussian parameter based on the loss value. In the optimization process of Gaussian, the scene is expressed precisely or unnecessary parts are removed by increasing or decreasing the number of Gaussians.

The optimized Gaussian obtained through repeated rendering and adaptive control is projected onto a two-dimensional image, and tile rasterization is performed on the projected image. After that, alpha blending (a-blending) is performed in depth order, starting with the Gaussian closest to the screen. The rendered image goes through a process of comparing it with the ground-truth image using the L1 loss function and the D-SSIM (Differential Structural Similarity) function.

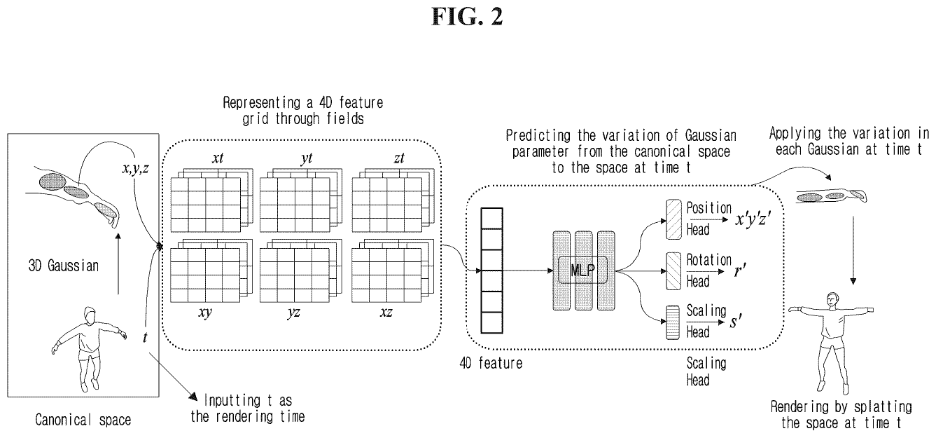

FIG. 2 is a diagram showing a field-based Gaussian splatting method. In general, in Gaussian splatting, a variation of a Gaussian parameter is predicted based on a Gaussian parameter and a specific timestamp for rendering. Here, Gaussian splatting is characterized by obtaining the variation of the Gaussian parameter based on a field. The field is expressed as a four-dimensional feature grid, with a position of the Gaussian and time as its axes. However, in Gaussian splatting according to FIG. 2, there is a problem that Gaussians at similar positions become entangled because Gaussians at similar positions have adjacent coordinates on the feature grid, and thus the variations in the Gaussian parameters for Gaussians are predicted similarly. Hereinafter, Gaussian entanglement will be examined in detail with reference to FIG. 3.

FIG. 3 is a diagram illustrating an example according to a field-based Gaussian splatting method. In the case of field-based Gaussian deformation, the variation is predicted as if movement has occurred even though it is a Gaussian existing in a static region. As an example, Gaussians (e.g., windows, closets, handles, etc.) of the first static region (the region indicated by the yellow box in the rendered image) and the second static region (the region indicated by the blue box in the rendered image) illustrated in FIG. 3 are predicted to have similar variations to Gaussians with movement (e.g., people, etc.). As a result, we can see that the images of the first static region and the second static region are rendered blurry as the Gaussians that exist in similar positions become entangled.

Accordingly, in this disclosure, a method for deriving position-independent Gaussian parameter variations for each Gaussian is provided using Gaussian embedding and/or temporal embedding. Hereinafter, a method for image encoding/decoding using a deformation function based on Gaussian embedding and/or temporal embedding according to the present disclosure will be described in detail.

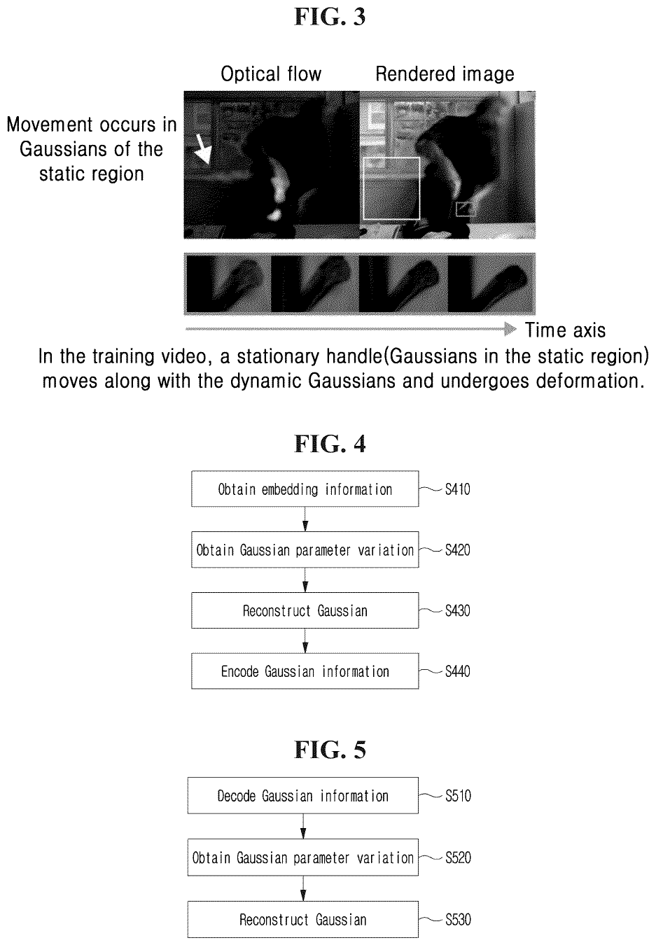

FIG. 4 is a flowchart to explain an image encoding method using a deformation function based on Gaussian embedding and/or temporal embedding, as an exemplary embodiment of the present disclosure.

Referring to FIG. 4, S410 is a step of obtaining embedding information. The embedding information means Gaussian embedding and/or temporal embedding.

The Gaussian embedding is obtained by inputting at least one Gaussian parameter. Information on at least one of spatial position, rotation, scale, transparency level, or color of a Gaussian is set as Gaussian parameter. As an example, a Gaussian parameter related to color pertains to spherical harmonic (SH) coefficients.

The Gaussian embedding according to one embodiment of the present disclosure is generated through learning of a network such as AI/ML, and represents the unique characteristics of each Gaussian for individual Gaussian. Gaussian embedding is derived individually for each Gaussian. The Gaussian embedding is expressed as an M-dimensional vector. M is a pre-defined natural number, and for example, the value of M is 32.

The temporal embedding means a P-dimensional feature vector representing the movement of a scene at a specific timestamp. The P-dimensional feature vector means a vector corresponding to a specific timestamp in a one-dimensional feature grid. Here, P is a pre-defined natural number. For example, the value of P is 256. The one-dimensional feature grid is expressed as a matrix (N×P) storing P-dimensional feature vectors for N frames. Here, N is a pre-defined natural number and is less than or equal to a total number of frames. For example, if the total number of frames is 300 frames, N is 150.

The temporal embedding is expressed as high-resolution temporal embedding or low-resolution temporal embedding. Here, the high-resolution temporal embedding and the low-resolution temporal embedding are generated to suit the characteristics of the scene through learning of networks such as AI/ML. That is, the high-resolution temporal embedding and the low-resolution temporal embedding are derived according to the dynamic state of the scene. The high-resolution temporal embedding and the low-resolution temporal embedding will be examined in detail in FIG. 8.

S420 illustrated in FIG. 4 is a step of deriving Gaussian parameter variation for each Gaussian based on embedding information. The Gaussian parameter variation is obtained by inputting the Gaussian embedding of the Gaussian in the canonical space for which variation is to be predicted and the temporal embedding in the canonical space into the deformation function. At this time, at least one of the high-resolution temporal embedding or the low-resolution temporal embedding is input into the deformation function.

S430 illustrated in FIG. 4 is a step for reconstructing Gaussian. When the Gaussian variation is obtained, the Gaussian parameter of the Gaussian located at the target timestamp is reconstructed based on the obtained variation. The Gaussian located at the target timestamp is obtained by applying the obtained variation to the Gaussian parameter located at the first timestamp. The Gaussian at the target timestamp is in a spatial correspondence relationship with the Gaussian in the canonical space.

S440 illustrated in FIG. 4 is a step of encoding Gaussian information. Gaussian information includes Gaussian parameter and/or embedding information. In order to obtain the same result in the image decoding device as in the image encoding device, Gaussian information is encoded and transmitted to the image decoding device.

Meanwhile, Gaussian embedding is transmitted by being encoded by Gaussian. Also, temporal embedding is transmitted in the form of a one-dimensional feature grid (N×P), representing a vector in a one-dimensional feature grid.

However, in the case of a static region within a scene, since the variation of the Gaussian parameter over time is constant, the process of obtaining the variation is omitted, and the storage and/or transmission of the Gaussian embedding is omitted. That is, when the scene is divided into the dynamic region and the static region, the method of obtaining the variation of the Gaussian parameter according to the present disclosure is applied only to the Gaussian belonging to the dynamic region.

FIG. 5 is a flowchart illustrating an image decoding method using a deformation function based on Gaussian embedding and/or temporal embedding, as an embodiment to which the present disclosure is applied.

Referring to FIG. 5, S510 illustrated in FIG. 5 is a step of decoding Gaussian parameter and/or embedding information from a bitstream transmitted from an image encoding device.

Gaussian information includes Gaussian parameter and/or embedding information. In addition, the embedding information includes Gaussian embedding and/or temporal embedding. The Gaussian embedding is obtained individually for each Gaussian, and the temporal embedding is obtained for each time on the time axis (temporal axis). The temporal embedding includes low-resolution temporal embedding and high-resolution temporal embedding.

S520 is a step of obtaining a variation of the Gaussian parameter. By inputting the decoded embedding information into a deformation function, the variation of the Gaussian parameter is obtained by at least one of a high-resolution image decoding device and/or a low-resolution image decoding device. Specifically, by inputting the Gaussian embedding in the canonical space and the time embedding at the target timestamp to be finally obtained into the deformation function, the variation of the Gaussian parameter with respect to the Gaussian between the canonical space and the target timestamp is obtained.

Meanwhile, to obtain the variation of the Gaussian parameter, at least one of high-resolution temporal embedding or low-resolution temporal embedding is used depending on whether the image decoding device is a high-resolution image decoding device or a low-resolution image decoding device.

S530 is a step for reconstructing Gaussian. By applying the Gaussian parameter variation for Gaussian at the target timestamp finally obtained in S520 and the Gaussian parameter for Gaussian at the current timestamp, Gaussian parameter deformed over time is obtained.

Rendering of a scene at a specific timestamp is performed based on the deformed Gaussian parameter. The scene is rendered by projecting the optimized Gaussian parameter onto the camera plane and performing a-blending in depth order.

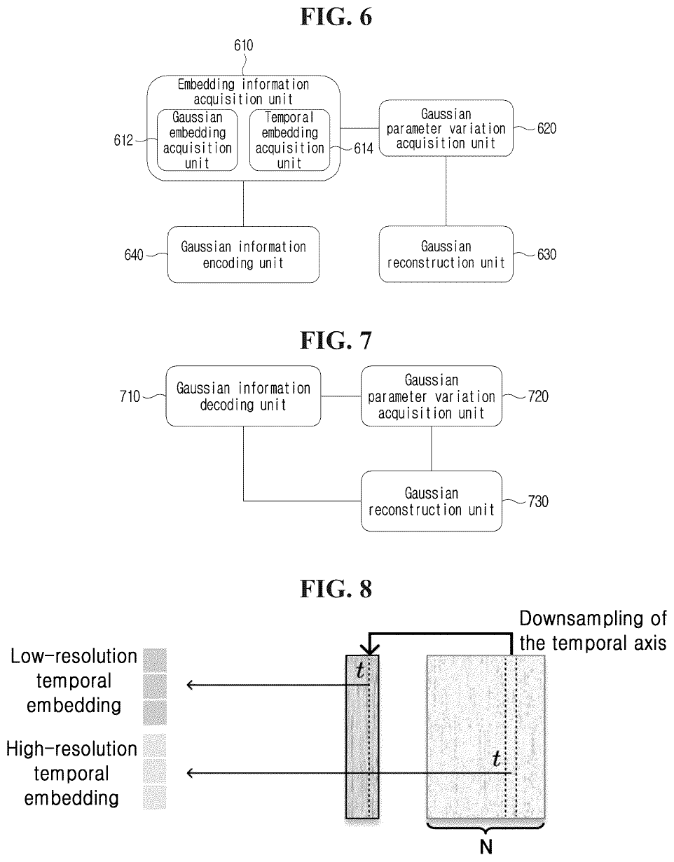

FIG. 6 schematically represents an image encoding device that performs an image encoding method according to an embodiment of the present disclosure. The method disclosed in FIG. 4 is performed by the image encoding device disclosed in FIG. 6. Specifically, the embedding information acquisition unit (610) of FIG. 6 performs S410 of FIG. 4. More specifically, the Gaussian embedding acquisition unit (612) of FIG. 6 obtains Gaussian embedding for each individual Gaussian, and the temporal embedding acquisition unit (614) obtains temporal embedding for each specific time. In addition, the Gaussian parameter variation acquisition unit (620) performs S420, and the Gaussian reconstruction unit (630) performs S430. The Gaussian information encoding unit (640) of the image encoding device performs S440 of FIG. 4.

FIG. 7 schematically shows an image decoding device that performs an image decoding method according to an embodiment of the present disclosure. The method disclosed in FIG. 5 is performed by the image decoding device disclosed in FIG. 7. Specifically, the Gaussian information decoding unit (710) of the image decoding device in FIG. 7 performs S510 of FIG. 5, the Gaussian parameter variation acquisition unit (720) of FIG. 7 performs S520 of FIG. 5, and the Gaussian reconstruction unit (730) of FIG. 7 performs S530 illustrated in FIG. 5.

FIG. 8 shows a process of deriving low-resolution temporal embedding by downsampling high-resolution temporal embedding according to one embodiment of the present disclosure.

High-resolution temporal embedding is obtained by sampling or interpolating a P-dimensional feature vector at an arbitrary time t in a one-dimensional feature grid (N×P). The high-resolution temporal embedding is used to model fast and detailed motion.

The low-resolution temporal embedding is obtained by downsampling the one-dimensional grid (N×P) for the high-resolution temporal embedding along the time axis to obtain a downsampled one-dimensional grid (N′×P). If the one-dimensional grid for the high-resolution temporal embedding is obtained with N frames, the one-dimensional grid for the low-resolution temporal embedding is obtained by reducing the N frames to 1/X times the number of frames. Here, X is a pre-defined natural number. For example, if a one-dimensional grid for high-resolution temporal embedding comprises 30 frames, P is a 256-dimensional vector, and X is 5, a one-dimensional grid for low-resolution temporal embedding has the form of (6×256). Based on the downsampled one-dimensional grid, low-resolution temporal embedding at an arbitrary time t is interpolated and generated.

The low-resolution temporal embedding allows for the expression of slow and large movements by eliminating high-frequency components that are responsible for expressing detailed and fast dynamics.

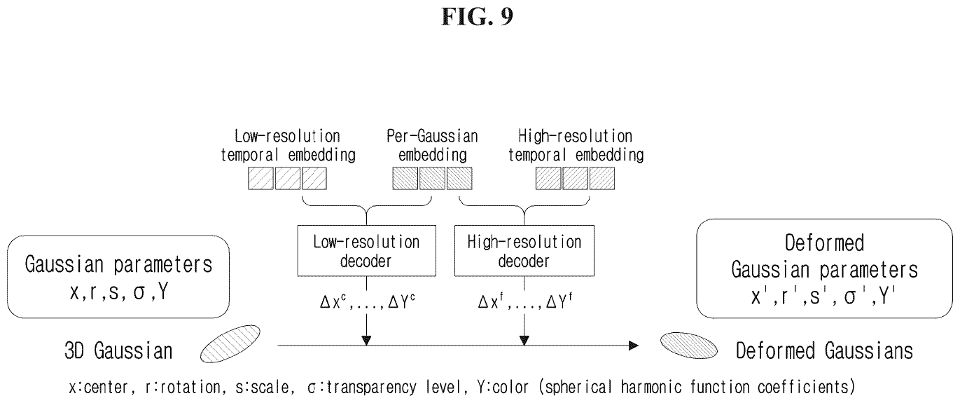

FIG. 9 is a diagram showing the structure of a deformation function for deriving a Gaussian parameter variation based on embedding information according to one embodiment of the present disclosure. Gaussian embedding and/or temporal embedding is input into the deformation function.

Gaussian embedding and temporal embedding are learned from the image error objective function used in Gaussian-based rendering techniques. The image error objective function is defined through local affine approximation.

Meanwhile, the transformation function receives at least one of high-resolution temporal embedding or low-resolution temporal embedding as input. That is, at least one of the high-resolution temporal embedding or the low-resolution temporal embedding is used to obtain the variation of the Gaussian parameter. Here, the temporal embedding input into the deformation function is determined according to the type of the image encoding/decoding device. In other words, it is determined depending on whether the image encoding/decoding device is a high-resolution image encoding/decoding device or a low-resolution image encoding/decoding device. According to one embodiment of the present disclosure, the high-resolution image encoding/decoding device and the low-resolution image encoding/decoding device comprise an MLP (Multi-layer perceptron) structure, and information about the network structure is pre-defined and used, and information about the network structure and parameters are additionally stored and/or transmitted. The MLP structure or MLP header comprises Z layers having Y hidden units. The Y and Z are pre-defined natural numbers or values adaptively determined according to the network structure. More specifically, the MLP structure comprises two layers having 128 hidden units. Alternatively, the MLP structure comprises one layer having 128 hidden units. Additionally, the MLP header for Gaussian parameter comprises two layers having 128 hidden units.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding an image, comprising:
decoding a Gaussian parameter and Gaussian embedding for a first Gaussian in a canonical space;
obtaining a variation of the Gaussian parameter for the first Gaussian by inputting the Gaussian embedding into a deformation function; and
reconstructing a second Gaussian at a target timestamp by applying the variation to the Gaussian parameter for the first Gaussian,
wherein the Gaussian embedding is derived individually for each Gaussian.

2. The method of claim 1, wherein the Gaussian embedding is expressed as a 32-dimensional vector.

3. The method of claim 1, wherein the variation is obtained by further inputting temporal embedding into the deformation function.

4. The method of claim 3, wherein the temporal embedding is expressed as a vector corresponding to at least one frame in a one-dimensional feature grid comprising N frames.

5. The method of claim 3, wherein the temporal embedding is derived for each dynamic state of a scene.

6. The method of claim 3, wherein a device for decoding the image that performs the method of decoding the image comprises a pre-defined network structure, and
wherein the pre-defined network structure comprises at least one layer, and the at least one layer has 128 hidden units.

7. The method of claim 3, wherein the temporal embedding is at least one of high-resolution temporal embedding or low-resolution temporal embedding depending on whether the device that performs the method of decoding the image is a high-resolution image decoding device or a low-resolution image decoding device.

8. The method of claim 7, wherein the high-resolution temporal embedding is obtained for each of N frames, and the low-resolution temporal embedding is obtained only for a frame at a downsampled position among the N frames.

9. The method of claim 8, wherein a downsampling rate is ⅕.

10. A device for decoding an image, comprising:
a Gaussian information decoding unit that decodes a Gaussian parameter and Gaussian embedding for a first Gaussian in a canonical space;
a Gaussian parameter variation acquisition unit that obtains a variation of the Gaussian parameter for the first Gaussian by inputting the Gaussian embedding into a deformation function; and
a Gaussian reconstruction unit that reconstructs a second Gaussian at a target timestamp by applying the variation to the Gaussian parameter for the first Gaussian,
wherein the Gaussian embedding is derived individually for each Gaussian.
